(19) United States
(12) Patent Application Publication
(10) Pub. No.: US 2025/0301060 A1
(43) Pub. Date: Sep. 25, 2025

(54) DRAWING-BASED UNLOCKING METHOD AND DEVICE

(71) Applicant: Nuvoton Technology Corporation, Hsinchu Science Park (TW)

(72) Inventor: Wei-Zong CHEN, Taoyuan City (TW)

(21) Appl. No.: 19/227,925

(22) Filed: Jun. 4, 2025

(30) Foreign Application Priority Data
Jul. 11, 2024 (TW) 113126003

(51) Int. Cl. H04M 1/72463; G06N 3/0464; G06N 3/08

(52) U.S. Cl. CPC H04M 1/72463; G06N 3/0464; G06N 3/08

(57) ABSTRACT

A drawing-based unlocking method is provided. The method is implemented by a device. The method includes training a recognition model. The method includes using the recognition model to identify whether a drawing style of a drawing belongs to an owner of the device when receiving the drawing that is input by a user. The method includes unlocking the device when the drawing style belongs to the owner. The method includes not unlocking the device when the drawing style does not belong to the owner.

### CROSS REFERENCE TO RELATED APPLICATIONS

This application claims priority from Taiwan Patent Application No. 113126003, filed on Jul. 11, 2024, the disclosure of which is incorporated herein in its entirety by reference.

### BACKGROUND OF THE INVENTION

### Field of the Invention

The present disclosure generally relates to an unlocking method and device. More specifically, aspects of the present disclosure relate to a drawing-based unlocking method and device.

### Description of the Related Art

With the ongoing development of electronic communication technology, portable electronic devices have become indispensable for transmitting information between devices. These devices include mobile phones, tablet computers, and the like. Since devices often have large storage capabilities and versatile functions, the user tends to develop a habit of storing a large quantity of private information in the device which demands a higher level of security on the device. Currently, methods for unlocking an electronic device include inserting numeric passwords, pattern lock, fingerprint recognition, voice recognition, facial recognition, and the like.

However, these modes of unlocking a screen appear more rigid, the user's operation and experience have also been limited, which may cause inconvenience for the user. Therefore, a drawing-based unlocking method and device are needed to achieve high security and enjoyment for users.

### SUMMARY

The following summary is illustrative only and is not intended to be limiting in any way. That is, the following summary is provided to introduce concepts, highlights, benefits and advantages of the novel and non-obvious techniques described herein. Select, not all, implementations are described further in the detailed description below. Thus, the following summary is not intended to identify essential features of the claimed subject matter, nor is it intended for use in determining the scope of the claimed subject matter.

Therefore, the main purpose of the present disclosure is to provide a drawing-based unlocking method and device.

In an exemplary embodiment, a drawing-based unlocking method is provided. The method is implemented by a device. The method includes training a recognition model. The method includes using the recognition model to identify whether a drawing style of a drawing belongs to an owner of the device when receiving the drawing that is input by a user. The method includes unlocking the device when the drawing style belongs to the owner. The method includes not unlocking the device when the drawing style does not belong to the owner.

In some embodiments, the step of training a recognition model further comprises obtaining a plurality of training drawings made by the owner, and training the recognition model based on the plurality of training drawings.

In some embodiments, a first pattern in the training drawings is different from a second pattern in the drawing.

In some embodiments, the drawing style includes a stroke, a composition, or a content.

In some embodiments, the recognition model performs recognition based on a neural network recognition model of MobileNet, and a recognition result is directly generated by the neural network recognition model.

In some embodiments, the method further comprises using the MobileNet to perform feature extraction and classification of the drawing, wherein an output layer of the MobileNet includes a set of classification probabilities of the drawing style. The method further comprises determining that the drawing style belongs to the owner, and unlocking the device when one classification probability in the set of classification probabilities of the drawing style is higher than a threshold. The method further comprises determining that the drawing style does not belong to the owner and not unlocking the device when the classification probabilities in the set are lower than the threshold.

In some embodiments, before receiving the drawing input by the user, the method further comprises providing a drawing prompt to the user to prompt the user to input the drawing, wherein the drawing prompt includes at least one of a text prompt and a voice prompt.

In some embodiments, the recognition model is based on a convolutional neural network (CNN) model.

In an exemplary embodiment, a drawing-based unlocking device is provided. The drawing-based unlocking device comprises one or more processors and one or more computer storage media for storing one or more computer-readable instructions. The processor is configured to drive the computer storage media to execute the following tasks. The computer storage media trains a recognition model. The computer storage media uses the recognition model to identify whether a drawing style of a drawing belongs to an owner of the drawing-based unlocking device when receiving the drawing that is input by a user. The computer storage media unlocks the drawing-based unlocking device when the drawing style belongs to the owner. The computer storage media does not unlocking the drawing-based unlocking device when the drawing style does not belong to the owner.

### BRIEF DESCRIPTION OF THE DRAWINGS

The accompanying drawings are included to provide a further understanding of the present disclosure, and are incorporated in and constitute a part of the present disclosure. The drawings illustrate implementations of the disclosure and, together with the description, serve to explain the principles of the disclosure. It should be appreciated that the drawings are not necessarily to scale as some components may be shown out of proportion to their size in actual implementation in order to clearly illustrate the concept of the present disclosure.

FIG. 1 is a schematic diagram illustrating a drawing-based unlocking device according to an embodiment of the present disclosure.

FIG. 2 is a flowchart illustrating a drawing-based unlocking method according to an embodiment of the present disclosure.

FIG. 3 is a schematic diagram illustrating training drawings according to an embodiment of the present disclosure.

FIG. 4 is a schematic diagram showing the network structure of MobileNetV3 according to an embodiment of the present disclosure.

FIG. 5 is a structural diagram showing an inverted residual block according to an embodiment of the present disclosure.

FIG. 6 illustrates an exemplary operating environment for implementing embodiments of the present disclosure.

### DETAILED DESCRIPTION OF THE INVENTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using number of the aspects set forth herein. In addition, the scope of the disclosure is intended to cover such an apparatus or method which is practiced using another structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects. Furthermore, like numerals refer to like elements throughout the several views, and the articles “a” and “the” includes plural references, unless otherwise specified in the description.

It should be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion. (e.g., “between” versus “directly between”, “adjacent” versus “directly adjacent”, etc.).

The embodiments of the present disclosure provide a drawing-based unlocking method and device, which utilizes each person's unique drawing style for identity verification and device unlocking, thereby achieving a high level of security for the device and bringing fun to users.

It should be noted that, the term “training”, as used herein, is used to recognize an object used to train a recognition model. Therefore, a training drawing refers to a drawing image used to train the recognition model.

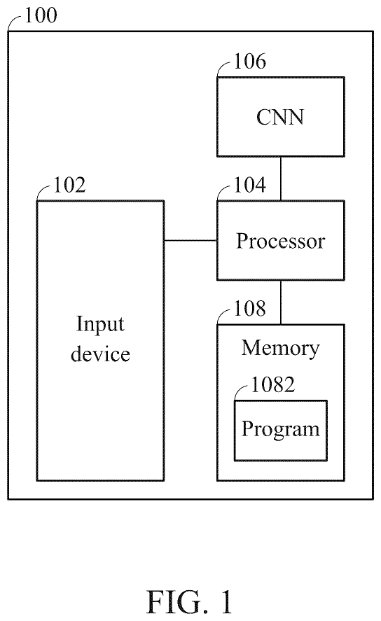

FIG. 1 is a schematic diagram illustrating a drawing-based unlocking device 100 according to an embodiment of the present disclosure.

The drawing-based unlocking device 100 may include an input device 102, wherein the input device 102 is configured to receive input data from a variety of sources. For example, the drawing-based unlocking device 100 may receive drawing data from the network or receive drawings transmitted by a user. The drawing-based unlocking device 100 may receive training drawings, and may further be trained as a recognizer configured to recognize drawing styles of the drawings according to the training drawings.

The drawing-based unlocking device 100 may include a processor 104, a convolutional neural network (CNN) 106 and a memory 108 which may store program 1082. In addition, the drawings may be stored in the memory 108 or in the convolutional neural network 106. In one embodiment, the convolutional neural network 106 may be implemented in the processor 104.

The types of drawing-based unlocking device 100 range from small handheld devices, such as mobile telephones and handheld computers to large mainframe systems, such as mainframe computers. Examples of handheld computers include personal digital assistants (PDAs) and notebooks.

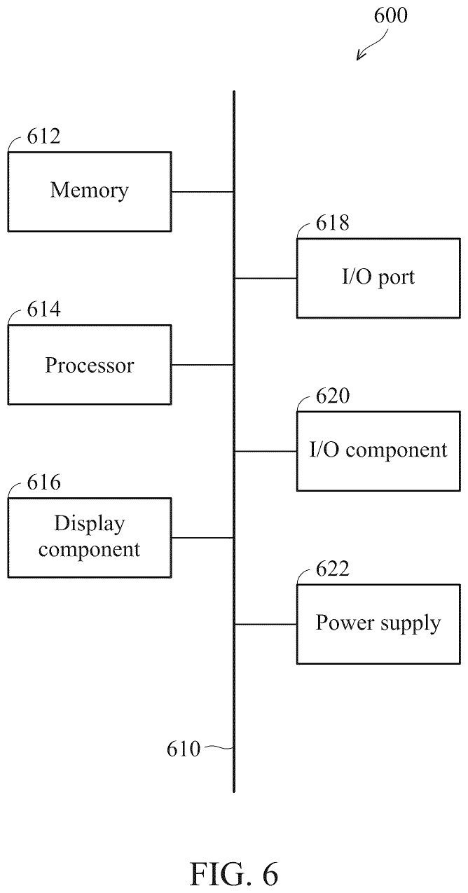

It should be understood that the drawing-based unlocking device 100 shown in FIG. 1 may be implemented via any type of computing device, such as the electronic device 600 described with reference to FIG. 6, for example.

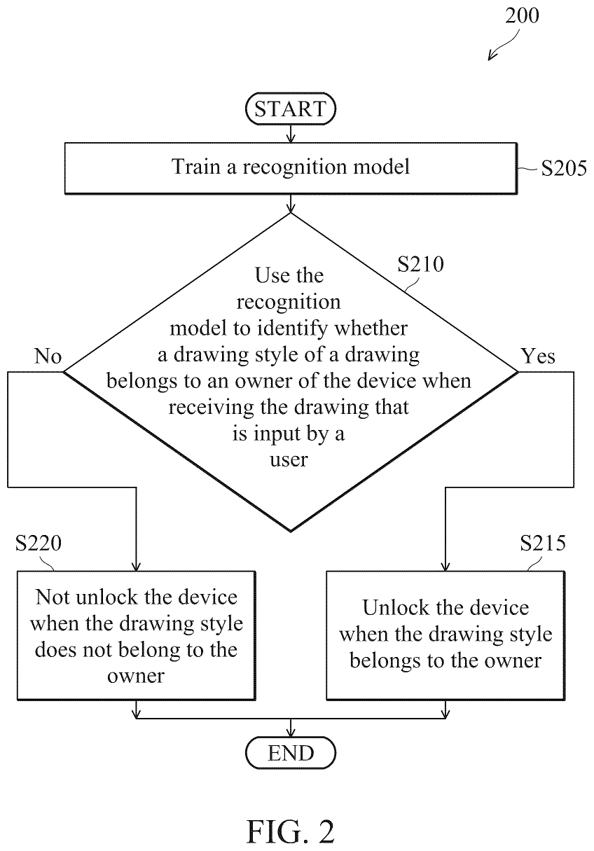

FIG. 2 is a flowchart illustrating a drawing-based unlocking method 200 according to an embodiment of the present disclosure. This method may be implemented by the processor 104 of the drawing-based unlocking device 100 in FIG. 1.

In step S205, the processor trains a recognition model, wherein the recognition model is based on a convolutional neural network (CNN) model. Specifically, the processor obtains a plurality of training drawings made and input by the owner of the drawing-based unlocking device and trains the recognition model based on the plurality of training drawings.

In step S210, when the processor receives a drawing that is input by a user, the processor uses the recognition model to identify whether a drawing style of the drawing belongs to an owner of the drawing-based unlocking device, wherein the drawing style includes a stroke, a composition, or a content.

When the drawing style of the drawing belongs to the owner of the drawing-based unlocking device (“Yes” in step S210), in step S215, the processor unlocks the drawing-based unlocking device.

When the drawing style of the drawing does not belong to the owner of the drawing-based unlocking device (“No” in step S210), in step S220, the processor does not unlock the drawing-based unlocking device.

In one embodiment, before step S210, the processor may provide a drawing prompt to the user to prompt the user to input the drawing, wherein the drawing prompt includes at least one of a text prompt and a voice prompt.

In one embodiment, the recognition model performs recognition based on a neural network recognition model of MobileNet, and a recognition result is directly generated by the above neural network recognition model. The processor uses the MobileNet to perform feature extraction and classification of the drawing, wherein an output layer of the MobileNet includes a set of classification probabilities of the drawing style. When one classification probability in the set of classification probabilities of the drawing style is higher than a threshold, the processor determines that the drawing style belongs to the owner and unlocks the device. When the classification probabilities in the set of classification probabilities are all lower than the threshold, the processor determines that the drawing style does not belong to the owner and does not unlock the device. In another embodiment, the threshold is preset by the processor or owner.

The process of how the drawing-based unlocking device trains the recognition model in step S205 to recognize the drawing style of the drawing will be described in detail below.

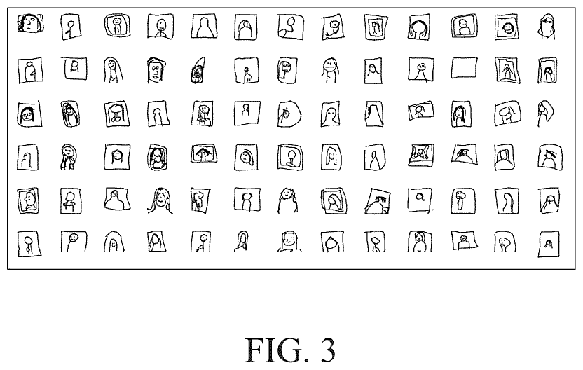

When the owner first enables the unlocking function of the drawing-based unlocking device, the processor may ask the owner to draw several unique training drawings in a designated area. FIG. 3 is a schematic diagram illustrating training drawings according to an embodiment of the present disclosure. As shown in FIG. 3, the processor provides a drawing prompt “person” to the owner to prompt the owner to draw several training drawings of “person”. It should be noted that the drawing prompt is not intended to limit the present disclosure, and those skilled in the art can make appropriate replacements or adjustments according to this embodiment.

Next, the processor performs preprocessing on the training drawings, where the preprocessing includes target detection, image alignment, image cropping, image scaling and other processing. The processor collects the training drawings in a training drawing set.

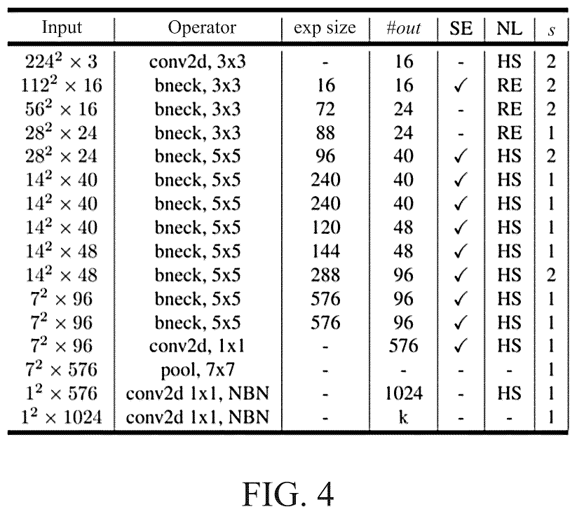

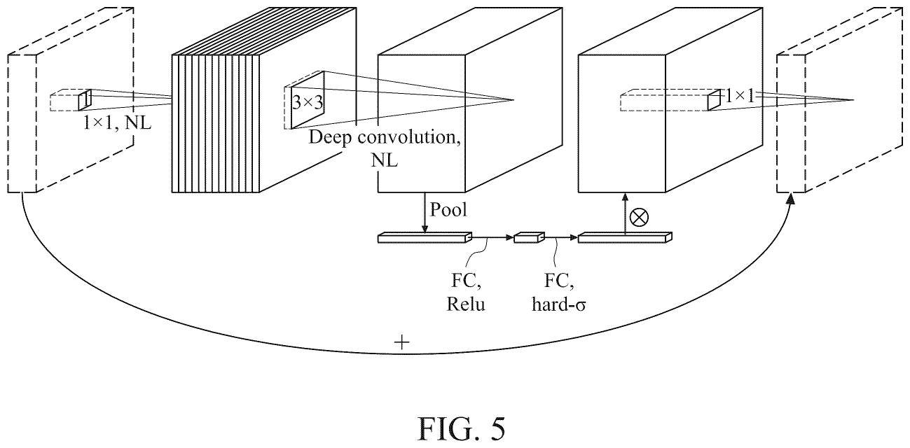

The processor constructs a neural network recognition model based on MobileNetV3 and uses the training drawing set to train the recognition model. MobileNetV3 can be used for classification, and the main part of MobileNetV3 is used to extract image features. The network structure of MobileNetV3 is shown in FIG. 4, wherein “Input” represents the shape change of each feature layer of MobileNetV3, and the “Operator” represents the block structure that each feature layer will go through, the extended dimension (“exp size”) and output dimension (“#out”) respectively represent the number of channels after bneck is increased and the number of channels in the feature layer when the inverted residual is inputted to the bneck. “SE” represents whether an attention mechanism is introduced in this layer. “NL” represents the type of nonlinear activation function, “HS” represents h-swish. “RE” represents ReLU and “s” represents the step size used in each block structure. The bneck is the inverted residual block of MobileNetV3, and the structure of the bneck is shown in FIG. 5.

In FIG. 5, the inverted residual block first performs 1×1 pointwise convolution on the input features to extend the features to high-dimensional features. Then, the depthwise convolution is performed on the high-dimensional features, and the convolution kernel size is fixed at 3×3. The nonlinear (NL) activation functions are used in the first and second layers. Finally, the inverted residual block uses 1×1 pointwise convolution to map high-dimensional features to low-dimensional features.

The processor recognizes the drawings input by the user through the trained recognition model. In one embodiment, a first pattern in the training drawings is different from a second pattern in the drawing. For example, during the stage of training the model, the processor may prompt the owner to input a plurality of training drawings of a “heart” pattern and use the plurality of training drawings (including the “heart” pattern) to train the recognition model. In the recognition stage, the processor may prompt the user to input a drawing of a “cake” pattern and recognize whether the drawing style of the “cake” pattern belongs to the owner.

It should be noted that although the recognition model is taken as an example of MobileNetV3 in this embodiment, it should not be limited in the present disclosure. For example, the recognition model may be based on the convolutional neural network model of MobileNetV3-Small or MobileNetV3-Large.

As mentioned above, a drawing-based unlocking method and device provided in the present disclosure uses each person's unique writing and drawing style to perform identity verification and device unlocking, thereby achieving a high level of security for the device and bringing fun to users.

Having described embodiments of the present disclosure, an exemplary operating environment in which embodiments of the present disclosure may be implemented is described below. Referring to FIG. 6, an exemplary operating environment for implementing embodiments of the present disclosure is shown and generally known as an electronic device 600. The electronic device 600 is merely an example of a suitable computing environment and is not intended to limit the scope of use or functionality of the disclosure. Neither should the electronic device 600 be interpreted as having any dependency or requirement relating to any one or combination of components illustrated.

The disclosure may be realized by means of the computer code or machine-useable instructions, including computer-executable instructions such as program modules, being executed by a computer or other machine, such as a personal data assistant (PDA) or other handheld device. Generally, program modules may include routines, programs, objects, components, data structures, etc., and refer to code that performs particular tasks or implements particular abstract data types. The disclosure may be implemented in a variety of system configurations, including hand-held devices, consumer electronics, general-purpose computers, more specialty computing devices, etc. The disclosure may also be implemented in distributed computing environments where tasks are performed by remote-processing devices that are linked by a communication network.

With reference to FIG. 6, the electronic device 600 may include a bus 610 that is directly or indirectly coupled to the following devices: one or more memories 612, one or more processors 614, one or more display components 616, one or more input/output (I/O) ports 618, one or more input/output components 620, and an illustrative power supply 622. The bus 610 may represent one or more kinds of busses (such as an address bus, data bus, or any combination thereof). Although the various blocks of FIG. 6 are shown with lines for the sake of clarity, and in reality, the boundaries of the various components are not specific. For example, the display component such as a display device may be considered an I/O component and the processor may include a memory.

The electronic device 600 typically includes a variety of computer-readable media. The computer-readable media can be any available media that can be accessed by the electronic device 600 and includes both volatile and nonvolatile media, removable and non-removable media. By way of example, not limitation, computer-readable media may comprise computer storage media and communication media. The computer storage media may include volatile and nonvolatile, removable and non-removable media implemented in any method or technology for storage of information such as computer-readable instructions, data structures, program modules or other data. The computer storage media may include, but not limit to, random access memory (RAM), read-only memory (ROM), electrically-erasable programmable read-only memory (EEPROM), flash memory or other memory technology, compact disc read-only memory (CD-ROM), digital versatile disks (DVD) or other optical disk storage, magnetic cassettes, magnetic tape, magnetic disk storage or other magnetic storage devices, or any other medium which can be used to store the desired information and which can be accessed by the electronic device 600. The computer storage media may not comprise signals per se.

The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, but not limitation, communication media includes wired media such as a wired network or direct-wired connection, and wireless media such as acoustic, RF, infrared and other wireless media or any combination thereof.

The memory 612 may include computer-storage media in the form of volatile and/or nonvolatile memory. The memory may be removable, non-removable, or a combination thereof. Exemplary hardware devices include solid-state memory, hard drives, optical-disc drives, etc. The electronic device 600 includes one or more processors that read data from various entities such as the memory 612 or the I/O components 620. The display component(s) 616 present data indications to a user or to another device. Exemplary presentation components include a display device, speaker, printing component, vibrating component, etc.

The I/O ports 618 allow the electronic device 600 to be logically coupled to other devices including the I/O components 620, some of which may be embedded. Illustrative components include a microphone, joystick, game pad, satellite dish, scanner, printer, wireless device, etc. The I/O components 620 may provide a natural user interface (NUI) that processes gestures, voice, or other physiological inputs generated by a user. For example, inputs may be transmitted to an appropriate network element for further processing. A NUI may be implemented to realize speech recognition, touch and stylus recognition, facial recognition, biometric recognition, gesture recognition both on screen and adjacent to the screen, air gestures, head and eye tracking, touch recognition associated with displays on the electronic device 600, or any combination thereof. The electronic device 600 may be equipped with depth cameras, such as stereoscopic camera systems, infrared camera systems, RGB camera systems, or any combination thereof, to realize gesture detection and recognition. Furthermore, the electronic device 600 may be equipped with accelerometers or gyroscopes that enable detection of motion. The output of the accelerometers or gyroscopes may be provided to the display of the electronic device 600 to carry out immersive augmented reality or virtual reality.

Furthermore, the processor 614 in the electronic device 600 can execute the program code in the memory 612 to perform the above-described actions and steps or other descriptions herein.

It should be understood that any specific order or hierarchy of steps in any disclosed process is an example of a sample approach. Based upon design preferences, it should be understood that the specific order or hierarchy of steps in the processes may be rearranged while remaining within the scope of the present disclosure. The accompanying method claims present elements of the various steps in a sample order, and are not meant to be limited to the specific order or hierarchy presented.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the disclosure has been described by way of example and in terms of the preferred embodiments, it should be understood that the disclosure is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A drawing-based unlocking method, implemented by a device, comprising:
training a recognition model;
using the recognition model to identify whether a drawing style of a drawing belongs to an owner of the device when receiving the drawing that is input by a user;
unlocking the device when the drawing style belongs to the owner; and
not unlocking the device when the drawing style does not belong to the owner.

2. The drawing-based unlocking method as claimed in claim 1, wherein the step of training a recognition model further comprises:
obtaining a plurality of training drawings made by the owner; and
training the recognition model based on the plurality of training drawings.

3. The drawing-based unlocking method as claimed in claim 2, wherein a first pattern in the training drawings is different from a second pattern in the drawing.

4. The drawing-based unlocking method as claimed in claim 1, wherein the drawing style includes a stroke, a composition, or a content.

5. The drawing-based unlocking method as claimed in claim 1, wherein the recognition model performs recognition based on a neural network recognition model of MobileNet, and a recognition result is directly generated by the neural network recognition model.

6. The drawing-based unlocking method as claimed in claim 5, further comprising:
using the MobileNet to perform feature extraction and classification of the drawing, wherein an output layer of the MobileNet includes a set of classification probabilities of the drawing style;
determining that the drawing style belongs to the owner, and unlocking the device when one classification probability in the set of classification probabilities of the drawing style is higher than a threshold; and
determining that the drawing style does not belong to the owner and not unlocking the device when the classification probabilities in the set are lower than the threshold.

7. The drawing-based unlocking method as claimed in claim 1, wherein before receiving the drawing input by the user, the method further comprises:
providing a drawing prompt to the user to prompt the user to input the drawing, wherein the drawing prompt includes at least one of a text prompt and a voice prompt.

8. The drawing-based unlocking method as claimed in claim 1, wherein the recognition model is based on a convolutional neural network (CNN) model.

9. A drawing-based unlocking device, comprising:
one or more processors; and
one or more computer storage media for storing one or more computer-readable instructions, wherein the processor is configured to drive the one or more computer storage media to execute the following tasks:
training a recognition model;
using the recognition model to identify whether a drawing style of a drawing belongs to an owner of the drawing-based unlocking device when receiving the drawing that is input by a user;
unlocking the drawing-based unlocking device when the drawing style belongs to the owner; and
not unlocking the drawing-based unlocking device when the drawing style does not belong to the owner.

10. The drawing-based unlocking device as claimed in claim 9, wherein the step of training a recognition model executed by the processor further comprises:
obtaining a plurality of training drawings made by the owner; and
training the recognition model based on the plurality of training drawings.

11. The drawing-based unlocking device as claimed in claim 10, wherein a first pattern in the training drawings is different from a second pattern in the drawing.

12. The drawing-based unlocking device as claimed in claim 9, wherein the drawing style includes a stroke, a composition, or a content.

13. The drawing-based unlocking device as claimed in claim 9, wherein the recognition model performs recognition based on a neural network recognition model of MobileNet, and a recognition result is directly generated by the neural network recognition model.

14. The drawing-based unlocking device as claimed in claim 13, wherein the processor is further configured to drive the one or more computer storage media to execute the following tasks:
using the MobileNet to perform feature extraction and classification of the drawing, wherein an output layer of the MobileNet includes a set of classification probabilities of the drawing style;
determining that the drawing style belongs to the owner, and unlocking the device when one classification probability of the set of classification probabilities of the drawing style is higher than a threshold; and
determining that the drawing style does not belong to the owner and not unlocking the drawing-based unlocking device when the classification probabilities in the set are lower than the threshold.

15. The drawing-based unlocking device as claimed in claim 9, wherein before receiving the drawing input by the user, the processor further executes the following task:
providing a drawing prompt to the user to prompt the user to input the drawing, wherein the drawing prompt includes at least one of a text prompt and a voice prompt.

16. The drawing-based unlocking device as claimed in claim 9, wherein the recognition model is based on a convolutional neural network (CNN) model.
